(19) United States
(12) Patent Application Publication
(10) Pub. No.: US 2026/0049863 A1
(43) Pub. Date: Feb. 19, 2026

(54) WEIGHING SYSTEM FOR FEED BIN

(71) Applicant: SWT Technologies Inc., Toronto (CA)

(72) Inventor: Xiaohui ZHENG, Toronto (CA)

(21) Appl. No.: 18/806,813

(22) Filed: Aug. 16, 2024

(51) Int. Cl. G01G 23/37; A01K 5/01; G01G 19/52; G01G 23/01; G06N 20/00

(52) U.S. Cl. CPC G01G 23/3735; A01K 5/01; G01G 19/52; G01G 23/01; G01G 23/3721; G06N 20/00

(57) ABSTRACT

The invention discloses a weighing system for a feed bin, including a load cell group, a controller, a cloud server and a client. The load cell group is configured to collect a loading pressure of feed bin legs. The controller is electrically connected with the load cell group, the controller is mounted on the feed bin, and the controller is configured to calculate and display discharging data of the feed bin. The cloud server is electrically connected with the controller, and the cloud server is configured to receive data sent by the controller and process the data. The client is electrically connected with the cloud server, and the client is configured to receive information sent by the cloud server.

### TECHNICAL FIELD

The invention belongs to the technical field of feed bins, and particularly relates to a weighing system for a feed bin.

### BACKGROUND

In farms, a feed bin is usually used to store feed, and a control system is used to control the discharging of feed in the feed bin. During breeding, the weighing of feed in the feed bin needs to be accurate and stable to ensure the accuracy of data on the weight of the feed discharged in different environments.

A weighing control system for a feed bin in the related art can weigh feed, provide accurate feed consumption data for the farm, and provide a basis for feed order processing, breeding monitoring, cost accounting and economic benefit analysis. However, in the actual process of weighing feed in the feed bin, the changes in the environment may easily lead to inaccurate data detection of the weighing system, thus failing to provide an accurate data foundation for farm management.

### SUMMARY

An objective of the invention is to provide a weighing system for a feed bin, in order to solve the problem in the prior art that changes in the environment may easily lead to inaccurate data detection by the controller, thus failing to provide an accurate data foundation for farm management.

Therefore, the invention provides a weighing system for a feed bin, including:
a load cell group, the load cell group being configured to collect a loading pressure of feed bin legs;
a controller, the controller being electrically connected with the load cell group, the controller being mounted on the feed bin, and the controller being configured to calculate and display discharging data of the feed bin;
a cloud server, the cloud server being electrically connected with the controller, and the cloud server being configured to receive data sent by the controller and process the data; and
a client, the client being electrically connected with the cloud server, and the client being configured to receive information sent by the cloud server.

Preferably, the load cell group is provided with a plurality of load cells mounted below support legs of the feed bin, and each support leg is correspondingly provided with one of the load cells.

Preferably, the controller includes a data calibration module, a data classification module, a data display module and a data uploading module. The data calibration module is electrically connected with the load cell group, and the data calibration module is configured to calibrate data collected by the load cell group. The data classification module is electrically connected with the data calibration module, and the data classification module is configured to classify the calibrated data. The data display module is electrically connected with the data classification module, and the data display module is configured to display data. The data uploading module is electrically connected with the data classification module, the data uploading module is electrically connected with the cloud server, and the data uploading module is configured to upload the data to the cloud server.

Preferably, the data calibration module includes a weighing calibration module, an air temperature calibration module, a weather calibration module, a vibration calibration module and a transportation pipeline calibration module. The weighing calibration module, the air temperature calibration module, the weather calibration module, the vibration calibration module and the transportation pipeline calibration module are electrically connected with the load cell group.

Preferably, the weighing calibration module is provided with a first linear regression algorithm model. The first linear regression algorithm model performs load cell fatigue drift compensation on weight data obtained by the load cells.

Preferably, the air temperature calibration module is provided with a second linear regression algorithm model. The second linear regression algorithm model performs temperature compensation on weight data of the load cells according to temperature changes.

Preferably, the weather calibration module is provided with a machine learning model. The machine learning model performs weather change compensation on weight data of the load cells according to humidity and wind speed.

Preferably, the data classification module classifies data into normal data and abnormal data by means of a clustering algorithm model.

Preferably, the cloud server includes a data receiving module, a data storage module, a data processing module, a data analysis module, an abnormality detection module, a data visualization module and an information sending module. The data receiving module is electrically connected with the controller, and the data receiving module is configured to receive data uploaded by the controller. The data storage module is electrically connected with the data receiving module, and the data storage module is configured to store data. The data processing module is electrically connected with the data storage module, and the data processing module is configured to preprocess data. The data analysis module is electrically connected with the data processing module, and the data analysis module is configured to analyze the preprocessed data. The abnormality detection module is electrically connected with the data analysis module, and the abnormality detection module is configured to detect abnormal data. The data visualization module is electrically connected with the data analysis module, and the data visualization module is configured to make data into report information. The information sending module is electrically connected with the data visualization module, and the information sending module is configured to send the report information to the client.

Preferably, the client includes an information receiving module, an information display module and an abnormality reminding module. The information receiving module is electrically connected with the information sending module, and the information receiving module is configured to receive the report information sent by the information sending module. The information display module is electrically connected with the information receiving module, and the information display module is configured to display the received report information. The abnormality reminding module is electrically connected with the abnormality detection module, and the abnormality reminding module is configured to provide a reminder when the abnormal data occur.

### Beneficial Effects:

1. According to the weighing system for a feed bin provided in the invention, the weight of the feed discharged from the feed bin is monitored by the controller, so that the discharging data is more accurate, and the weighing system can adapt to different use environments, thereby ensuring accuracy and reliability of the discharging data.
2. By means of the cooperation between the data collection module and the data calibration module in the invention, the collected data are compensated according to the fatigue degree of the load cells, the temperature, humidity and wind speed in the environment where the load cells are located, and vibrations of the load cells and the transportation pipeline during discharging, so that accurate weight data can be obtained finally.
3. According to the invention, the controller, the cloud server and the client are networked so as to transmit the data or information. The cloud server summarizes and analyzes the data to form the report information, and sends the report information to the client, so that the user can check the report information at any time through the client and master the feed remaining and the feed consumed in the feed bin, thereby reducing the management cost.

### BRIEF DESCRIPTION OF THE DRAWINGS

In order to more clearly illustrate the embodiments of the invention or the technical solutions in the prior art, the accompanying drawings used in the description of the embodiments or the prior art will be briefly described below. Apparently, the accompanying drawings in the following description are only some embodiments of the invention, and those skilled in the art can obtain other drawings according to these drawings without any creative work.

FIG. 1 is a schematic system structure diagram of a weighing system for a feed bin according to Embodiment 1 of the invention.

### DESCRIPTION OF THE EMBODIMENTS

The contents of the invention can be more easily understood with reference to the following detailed description of preferred implementations of the invention and the embodiments included. Unless otherwise defined, all technical and scientific terms used herein have the same meaning as commonly understood by those of ordinary skill in the art to which the invention belongs. In case of contradiction, the definition in this specification shall prevail.

### Embodiment 1

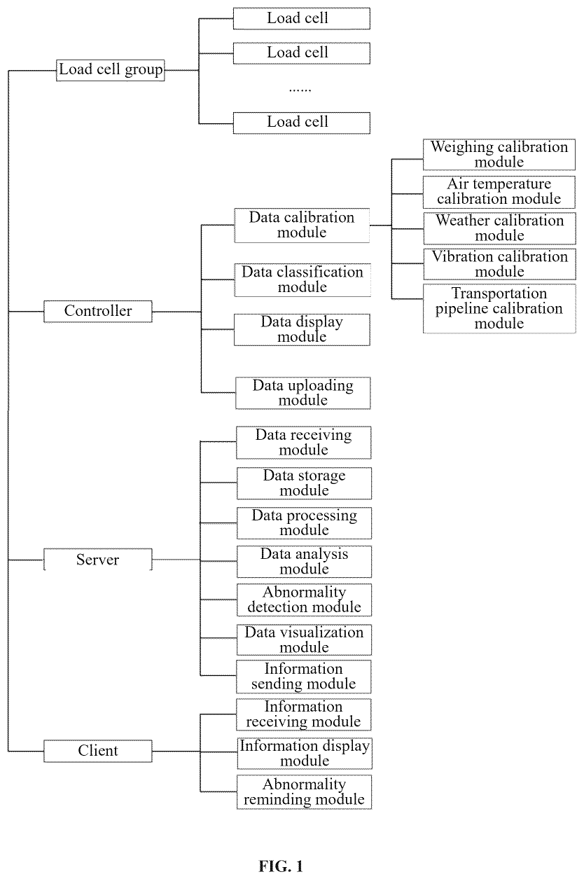

As shown in FIG. 1, a weighing system for a feed bin includes: a load cell group, a controller, a cloud server and a client.

The load cell group is electrically connected with a controller, and the load cell group is configured to collect a loading pressure of feed bin legs.

The load cell group is provided with a plurality of load cells mounted below support legs of the feed bin, and each support leg is correspondingly provided with one of the load cells.

The controller is mounted on the feed bin, and the controller is configured to control discharging of the feed bin.

The controller includes a data calibration module, a data classification module, a data display module and a data uploading module. The data calibration module is electrically connected with the load cell group, and the data calibration module is configured to calibrate data collected by the load cell group. The data classification module is electrically connected with the data calibration module, and the data classification module is configured to classify the calibrated data. The data display module is electrically connected with the data classification module, and the data display module is configured to display data. The data uploading module is electrically connected with the data classification module, the data uploading module is electrically connected with the cloud server, and the data uploading module is configured to upload the data to the cloud server.

The data calibration module includes a weighing calibration module, an air temperature calibration module, a weather calibration module, a vibration calibration module and a transportation pipeline calibration module. The weighing calibration module, the air temperature calibration module, the weather calibration module, the vibration calibration module and the transportation pipeline calibration module are electrically connected with the load cell group.

The weighing calibration module is provided with a first linear regression algorithm model. The first linear regression algorithm model performs load cell fatigue drift compensation on weight data obtained by the load cells.

The first linear regression algorithm model includes: Regression coefficients β₀ and β₁ are solved according to sensor output data y in time t obtained by the load cells, where β₀ represents the intercept, and β₁ represents the slope.

$${β}_{1} = \frac{n ( \sum {y}_{i} {t}_{i} ) - ( \sum {t}_{i} ) ( \sum {y}_{i} )}{n ( \sum {t}_{i}^{2} ) - {( \sum {t}_{i} )}^{2}}$$

$${β}_{0} = \frac{\sum {y}_{i}}{n} - {β}_{1} ( \frac{\sum {t}_{i}}{n} )$$

$$t = \{ {t}_{0} , {t}_{1} , {t}_{2} , … , {t}_{n} \} , y = \{ {y}_{0} , {y}_{1} , {y}_{2} , … , {y}_{n} \} , 0 \leq i \leq n ;$$

A linear model y=β₀+β₁t is fitted, and the drift at each time t is calculated.

The fitted trend line is used to compensate for the drift in the raw data so as to eliminate the long term drift caused by sensor fatigue, thereby obtaining the data after compensation γ_{comp}.

$${y}_{comp} = y - ( {β}_{0} + {β}_{1} t )$$

The air temperature calibration module is provided with a multivariate linear regression algorithm model. The multivariate linear regression algorithm model performs temperature compensation on weight data of the load cells according to temperature changes.

The second linear regression algorithm model includes:

Regression coefficients β₂ and β₃ are solved according to the temperature T obtained by a temperature sensor and the weight w after the sensor fatigue compensation, where β₂ represents the intercept, and β₃ represents the slope.

$${β}_{3} = \frac{n ( \sum {w}_{i} {T}_{i} ) - ( \sum {T}_{i} ) ( \sum w )}{n ( \sum {T}_{i}^{2} ) - {( \sum {T}_{i} )}^{2}}$$

$${β}_{2} = \frac{\sum {w}_{i}}{n} - {β}_{3} ( \frac{\sum {T}_{i}}{n} )$$

$$T = \{ {T}_{0} , {T}_{1} , T , … , {T}_{n} \} , y = \{ {w}_{0} , {w}_{1} , w , … , {w}_{n} \} , 0 \leq i \leq n ;$$

A linear model w=β₂+β₃T is fitted, and the offset at each temperature T is calculated.

The fitted trend line is used to compensate for the offset in the raw data so as to eliminate the error caused by the temperature changes, thereby obtaining the data after compensation w_{comp1},

$${w}_{comp 1} = w - ( {β}_{2} + {β}_{3} T )$$

The weather calibration module is provided with a machine learning model. The machine learning model performs weather change compensation on weight data of the load cells according to humidity and wind speed.

In this embodiment, the machine learning model is the decision tree CART. When training the decision tree CART model, datasets of load cell readings, humidities and wind speeds are made first, and data are recursively partitioned by using the CART algorithm with the humidity and wind speed as input features of the model and the actual readings of the load cells as the target variable until stop conditions are met. Different partitioning points are tried for each feature, and the partitioning point that can minimize the mean square error is selected. The above process is repeated for each partitioned subset until the preset maximum tree depth or the minimum sample size is reached or further partitioning cannot significantly reduce the mean square error. When in use, the compensation value is predicted according to the actual reading of the load cells by using the constructed decision tree CART model.

The calculation formula of the mean square error MSE is

$$M S E ( D ) = \frac{1}{m} {\sum }_{i = 1}^{m} {( {y}_{i} - {y}_{D}^{′} )}^{2}$$

where D is the current data subset, m is the sample size in the subset, yᵢ is the i-th sample, and y′_{D} is the predicted reading of the subset D.

The machine learning model includes a compensation function ƒ(H, V) obtained by training the decision tree, where H is the humidity data obtained by a humidity sensor, and V is the wind speed data obtained by a wind speed sensor.

The influence of the changes in humidity and wind speed on the weighing data is eliminated to obtain the value after compensation w_{comp2}=w_{comp1}−ƒ(H,V).

The vibration calibration module is provided with a high-pass filter. The sensor data of a vibration sensor is h, and the transfer function of the high-pass filter is H(ƒ). Low-frequency interference caused by vibration and swing is eliminated to obtain the filtered vibration data h_{filtered}=H(ƒ)h.

The transportation pipeline calibration module is provided with a short-time Fourier transform model. The short-time Fourier transform model is used to identify special interference bands so as to perform filtration, thereby obtaining the filtered pipeline vibration data.

The data classification module classifies data into normal data and abnormal data by means of a clustering algorithm model. The normal data are stable data obtained by filtering out general interfering factors, and the abnormal data are data caused by non-general interfering factors, such as sensor failure or other abnormal conditions.

The data display module is provided with a display screen. The data display module displays, on the display screen, the normal data and the abnormal data in the data classification module.

The data uploading module uploads the normal data and the abnormal data to the cloud server.

The cloud server is electrically connected with the controller, and the cloud server is configured to receive data sent by the controller. In this embodiment, the controller sends data to the cloud server by means of a wireless network.

The cloud server includes a data receiving module, a data storage module, a data processing module, a data analysis module, an abnormality detection module, a data visualization module and an information sending module.

The data receiving module is electrically connected with the controller, and the data receiving module is configured to receive the normal data and the abnormal data uploaded by the controller. The data uploading module sends a data packet to the data receiving module by means of a network protocol. The data packet includes timestamp, sensor ID, data type, sensor reading and related environmental parameters.

The data storage module is electrically connected with the data receiving module, and the data storage module is configured to store data.

The data processing module is electrically connected with the data storage module, and the data processing module is configured to preprocess data.

The data preprocessing of the data processing module includes: missing value processing: checking whether there are missing values in the data, and processing them using interpolation, mean filling and other methods; outlier detection: identifying and processing outliers using statistical methods or machine learning methods; and data normalization: normalizing or standardizing data for subsequent analysis. The purpose of the data preprocessing is to improve data quality and ensure the accuracy and reliability of data analysis.

The data analysis module is electrically connected with the data processing module, and the data analysis module is configured to analyze the preprocessed data. The data analysis module includes descriptive statistical analysis, including mean, variance, standard deviation, maximum, minimum and the like. The basic features of data are described by calculating statistics. Time series analysis: The time trend and periodicity of data are analyzed using ARIMA model, exponential smoothing, etc., which identifies the trend and periodicity by analyzing the time series pattern of data so as to predict the future. Correlation analysis: The correlation between different sensor data is analyzed using Pearson correlation coefficient, Spearman correlation coefficient, etc., which analyzes the relationship between different variables by calculating the correlation coefficient. Prediction model: A prediction model is created using a machine learning algorithm to predict future data trends, which trains the machine learning model based on historical data so as to predict the future. Classification and cluster analysis: The data are classified and subjected to cluster analysis using K-means, hierarchical clustering, DBSCAN and other algorithms, which divides the data into different categories or clusters by analyzing the features of data for further analysis.

The abnormality detection module is electrically connected with the data analysis module, and the abnormality detection module is configured to detect abnormal data. The abnormality detection module detects the abnormal data using statistical methods or machine learning methods. Once abnormal data are detected, an alarm system is triggered and alarm information is sent to relevant personnel.

The data visualization module is electrically connected with the data analysis module, and the data visualization module is configured to make data into report information. The data visualization module sorts and preprocesses the data according to the type and purpose of the data that need to be visualized, and creates a variety of visualized data forms such as charts, dashboards and data reports.

The information sending module is electrically connected with the data visualization module, and the information sending module is configured to send the report information to the client.

The client is electrically connected with the cloud server, and the client is configured to receive information sent by the cloud server.

The client includes an information receiving module, an information display module and an abnormality reminding module. The information receiving module is electrically connected with the information sending module, and the information receiving module is configured to receive the report information sent by the information sending module. The information display module is electrically connected with the information receiving module, and the information display module is configured to display the received report information. The abnormality reminding module is electrically connected with the abnormality detection module, and the abnormality reminding module is configured to provide a reminder when the abnormal data occur.

What is claimed is:

1. A weighing system for a feed bin comprises:
a load cell group, the load cell group being configured to collect a loading pressure of feed bin legs;
a controller, the controller being electrically connected with the load cell group, the controller being mounted on the feed bin, and the controller being configured to calculate and display discharging data of the feed bin;
a cloud server, the cloud server being electrically connected with the controller, and the cloud server being configured to receive data sent by the controller and process the data; and
a client, the client being electrically connected with the cloud server, and the client being configured to receive information sent by the cloud server.

2. The weighing system for a feed bin according to claim 1, wherein the load cell group is provided with a plurality of load cells mounted below support legs of the feed bin, and each support leg is correspondingly provided with one of the load cells.

3. The weighing system for a feed bin according to claim 1, wherein the controller comprises a data calibration module, a data classification module, a data display module and a data uploading module; the data calibration module is electrically connected with the load cell group, and the data calibration module is configured to calibrate data collected by the load cell group; the data classification module is electrically connected with the data calibration module, and the data classification module is configured to classify the calibrated data; the data display module is electrically connected with the data classification module, and the data display module is configured to display data; and the data uploading module is electrically connected with the data classification module, the data uploading module is electrically connected with the cloud server, and the data uploading module is configured to upload the data to the cloud server.

4. The weighing system for a feed bin according to claim 3, wherein the data calibration module comprises a weighing calibration module, an air temperature calibration module, a weather calibration module, a vibration calibration module and a transportation pipeline calibration module, the weighing calibration module, the air temperature calibration module, the weather calibration module, the vibration calibration module and the transportation pipeline calibration module are electrically connected with the load cell group.

5. The weighing system for a feed bin according to claim 4, wherein the weighing calibration module is provided with a first linear regression algorithm model, the first linear regression algorithm model performing load cell fatigue drift compensation on weight data obtained by the load cells.

6. The weighing system for a feed bin according to claim 4, wherein the air temperature calibration module is provided with a second linear regression algorithm model, the second linear regression algorithm model performing temperature compensation on weight data of the load cells according to temperature changes.

7. The weighing system for a feed bin according to claim 4, wherein the weather calibration module is provided with a machine learning model, the machine learning model performing weather change compensation on weight data of the load cells according to humidity and wind speed.

8. The weighing system for a feed bin according to claim 2, wherein the data classification module classifies data into normal data and abnormal data by means of a clustering algorithm model.

9. The weighing system for a feed bin according to claim 1, wherein the cloud server comprises a data receiving module, a data storage module, a data processing module, a data analysis module, an abnormality detection module, a data visualization module and an information sending module; the data receiving module is electrically connected with the controller, and the data receiving module is configured to receive data uploaded by the controller; the data storage module is electrically connected with the data receiving module, and the data storage module is configured to store data; the data processing module is electrically connected with the data storage module, and the data processing module is configured to preprocess data; the data analysis module is electrically connected with the data processing module, and the data analysis module is configured to analyze the preprocessed data; the abnormality detection module is electrically connected with the data analysis module, and the abnormality detection module is configured to detect abnormal data; the data visualization module is electrically connected with the data analysis module, and the data visualization module is configured to make data into report information; and the information sending module is electrically connected with the data visualization module, and the information sending module is configured to send the report information to the client.

10. The weighing system for a feed bin according to claim 9, wherein the client comprises an information receiving module, an information display module and an abnormality reminding module; the information receiving module is electrically connected with the information sending module, and the information receiving module is configured to receive the report information sent by the information sending module; the information display module is electrically connected with the information receiving module, and the information display module is configured to display the received report information; and the abnormality reminding module is electrically connected with the abnormality detection module, and the abnormality reminding module is configured to provide a reminder when the abnormal data occur.
